(19) United States
(12) Patent Application Publication
(10) Pub. No.: US 2021/0224324 A1
(43) Pub. Date: Jul. 22, 2021

(54) GRAPH-BASED ACTIVITY DISCOVERY IN HETEROGENEOUS PERSONAL CORPORA

(71) Applicant: Microsoft Technology Licensing, LLC, Redmond, WA (US)

(72) Inventors: Adam FOURNEY, Bothell, WA (US); Robert Alexander SIM, Bellevue, WA (US); Shane Frandon WILLIAMS, Seattle, WA (US); Paul Nathan BENNETT, Redmond, WA (US); Tara Lynn SAFAVI, San Jose, CA (US)

(73) Assignee: Microsoft Technology Licensing, LLC, Redmond, WA (US)

(21) Appl. No.: 16/780,648

(22) Filed: Feb. 3, 2020

Related U.S. Application Data
(60) Provisional application No. 62/963,437, filed on Jan. 20, 2020.

(51) Int. Cl. G06F 16/901; G06F 16/9538

(52) U.S. Cl. CPC G06F 16/9024; G06F 16/9538

(57) ABSTRACT

The present disclosure relates to systems and methods for discovering relatedness between entities from a corpora of information by automatically extracting attributes from the plurality of heterogeneous entities in a graph. A standardized representation of the extracted attributes from the plurality of heterogeneous entities are propagated across the graph and these propagated attributes are used to find a degree to which the plurality of heterogeneous entities are associated with the extracted attributes. The degree to which the plurality of heterogeneous entities are associated with the extracted attributes is used to create a representation space illustrating a level of relatedness of an entity to another entity of the plurality of heterogeneous entities. The representation space may be efficiently updated when updates to the graph are received by determining a delta representation space caused by the update to the graph and creating a new representation space by adding the delta representation space to the representation space.

### CROSS-REFERENCE TO RELATED APPLICATIONS

This application claims priority to and the benefit of U.S. Provisional Patent Application No. 62/963,437, filed on Jan. 20, 2020, the disclosure of which is hereby incorporated by reference in its entirety.

### BACKGROUND

Individuals' information collections (their emails, files, appointments, web searches, contacts, etc.) offer a wealth of insights into the organization and structure of their everyday lives. However, there is often a large volume of this type of information and it is difficult and time consuming to organize this low-level information by higher level activities, such as projects and tasks. For example, modern email clients support tagging and foldering, but individuals struggle to maintain these efforts because manual organization and/or curation is costly. Thus, there is a need to help people better organize, retrieve, and utilize their information.

Semantic and conversational search systems also lack an efficient way of inferring users' high-level activities from low-level entities, such as emails, appointments, contacts etc. Without manual curation or organization, such systems do not allow users to directly search by concept or activity (e.g., “Show me all receipts related to my home remodel”).

However, solving these problems comes with unique challenges. For one, people's activities are complex and fluid. They can exist on varying time scales and evolve over time. Some activities overlap with, or subsume, one another. Ideally, automated approaches to activity discovery should be able to capture such complexity.

Another challenge is that the entities to which a user is connected are constantly evolving. New emails arrive, files are shared for the first time, people join new projects etc. While computing the relatedness of a large number of information items is possible, doing it for every update to a user's information is prohibitively computationally costly. One solution is to only update it on occasion (e.g. after every week), however this can lead to a very poor representation of relatedness when the information is changing quickly (e.g. for people who receive high volumes of email). Thus, there is a need to update relatedness of these low-level information items “online,” meaning every time the information changes.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In light of the above limitations, systems and methods are provided herein relate to the automatic discovery of users' high-level “activities” (projects, tasks) from the low-level entities in their corpora, toward the ultimate goal of helping users better organize, retrieve, and utilize their information.

An exemplary method models a user's corpus, or corpora of multiple users, as a graph, and then learns a representation of the graph's entities (e.g., an individual's emails, meetings, documents, etc.) such that heterogeneous entities are represented in a shared space, with similar representations for entities related by “activity.” This exemplary model is lightweight enough to train on-device for user privacy, does not require user-input labels but can incorporate them if available, and allows for incremental updating of representations as new user data arrive. Aspects of this disclosure may be leveraged to perform activity-based recommendation of documents, recipients and other actions, as well as automatic clustering/organization of documents, emails, etc.

At a high level, aspects disclosed herein relate to constructing a “graph” of one's information (e.g., corpora), for example, by connecting people to meetings and emails based on the attendee and recipient lists, respectively. Each item of information (e.g., emails, files, appointments, web searches, contacts) is a node or entity in the graph and the nodes are connected together by edges (e.g., their relationships to each other). Short pieces of text, for example, key phrases from email subject lines, are automatically extracted from text-bearing entities or nodes (referred to as “seed entities”) in the “graph.” These text snippets serve as labels or attributes and seeds, among other entity properties, in the attribute propagation stage. The attributes or labels of seed entities are propagated across the graph's structure. This results in a representation space, such as a matrix of entities mapped against attributes, where each row in the matrix is a representation of an entity, each attribute is represented in a column, and each entry (e.g., intersection of a row and column) in the matrix describes the degree to which an entity is associated with an attribute.

The representation space is updated to include new entities and/or attributes as new information arrives (e.g., documents, emails, etc.) via a localized version of the propagation operation described. By updating the representation space, the method is, in effect, updating each entity's representation. Aspects disclosed herein, among other benefits, provide for updating the representation space in an online manner, namely every time the graph changes, many orders of magnitude faster than its offline counterpart, by reusing prior computations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1A illustrates an exemplary system diagram in accordance with aspects of the present disclosure.

FIG. 1B illustrates an exemplary corpora for a user in accordance with aspects of the present disclosure.

FIG. 2 illustrates an exemplary graph illustrating relationships between entities within the corpora of FIG. 1B in accordance with aspects of the present disclosure.

FIG. 3 illustrates an exemplary graph illustrating seed entities within the corpora of FIG. 1B in accordance with aspects of the present disclosure.

FIG. 4A illustrates an exemplary seed entity with attributes and the standardization of the attributes in accordance with aspects of the present disclosure.

FIG. 4B illustrates an exemplary seed entity with attributes and the standardization of the attributes in accordance with aspects of the present disclosure.

FIG. 4C illustrates an exemplary seed entity with attributes and the standardization of the attributes in accordance with aspects of the present disclosure.

FIG. 4D illustrates an exemplary seed entity with attributes and the standardization of the attributes in accordance with aspects of the present disclosure.

FIG. 5 is an exemplary diagram depicting attribute propagation for a seed entity through a graph in accordance with aspects of the present disclosure.

FIG. 6 is an exemplary diagram depicting attribute propagation through a matrix in accordance with aspects of the present disclosure.

FIG. 7 illustrates an exemplary diagram of entity clustering based on propagation of attributes in a matrix in accordance with aspects of the present disclosure.

FIG. 8 illustrates an exemplary method for determining the degree of relatedness between heterogeneous entities from a graph in accordance with aspects of the present disclosure.

FIG. 9 illustrates an exemplary method for updating a representation space as new information arrives in accordance with aspects of the present disclosure.

FIG. 10A illustrates an exemplary graph with a new edge in accordance with aspects of the present disclosure

FIG. 10B illustrates an exemplary method updating the representation space for a graph based on the addition of a new edge between existing entities in accordance with aspects of the present disclosure.

FIG. 11A illustrates an exemplary graph with a new attribute in accordance with aspects of the present disclosure.

FIG. 11B illustrates an exemplary method of updating the representation space for a graph based on the addition of a new attribute to an existing entity in accordance with aspects of the present disclosure.

FIG. 12A illustrates an exemplary graph with a new entity in accordance with aspects of the present disclosure.

FIG. 12B illustrates an exemplary graph with a new entity in accordance with aspects of the present disclosure.

FIG. 12C illustrates an exemplary method of updating the representation space for a graph based on the addition of an entity that is connected via a new edge to a graph in accordance with aspects of the present disclosure.

FIG. 13 is a block diagram illustrating example physical components of a computing device with which aspects of the disclosure may be practiced.

FIG. 14A is a simplified diagram of a mobile computing device with which aspects of the present disclosure may be practiced.

FIG. 14B is another are simplified block diagram of a mobile computing device with which aspects of the present disclosure may be practiced.

In the attached figures, like numerals in different drawings are associated with like components or elements. A letter following a numeral illustrates one member of a group of elements that may all be represented by the same numeral.

### DETAILED DESCRIPTION

### Overview

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure addresses the task of learning representations of information items to capture ongoing activities, such as projects and tasks. Such representations can be used in activity-centric applications like assistants, email clients, and productivity tools to help people better manage their data and time. Aspects use a graph-based approach that leverages the inherent interconnected structure of information collections, and derives efficient, exact techniques to incrementally update representations as new data arrive. Specifically, guided by the concept of associations between items, the systems and methods learn representations of information objects such that objects related by activity have similar representations and can be directly compared regardless of type.

Information collections or corpora are modeled as graphs and unsupervised entity representations are learned with a propagation-based objective. Entity representations are updated as new data arrive, up to hundreds or even thousands of times faster than learning from scratch. This model can produce human-interpretable representations, and can also implicitly capture semantic differences in entity types while still representing items in a common space.

The systems and methods described herein confer a number of advantages compared to prior work. These include the ability to learn the model on-device, in a privacy preserving manner. In one exemplary aspect, the method does not exploit collective patterns across users due to the private nature of corpora. As such, the method may handle data sparsity accordingly and be space- and time-efficient In another exemplary aspect, the method may evaluate corpora across users to identify low-level entities that relate to high level activities for a group of users, such as a team within an enterprise, with privacy constraints lessened.

Another benefit is the ability to learn the representations (e.g., row in a matrix) without strong supervision, that is, without requiring manually provided labels. Manually organizing corpora (e.g., social circles, email tags or folders) requires a nontrivial amount of user effort, and is often not maintained over extended periods of time. Therefore the systems and methods described herein operate primarily in an unsupervised setting, although they can incorporate user-given labels if available (e.g., names of mail folders, channels in a collaboration platform, etc.). Yet another benefit is the ability to update the graph and representation very quickly, as new items arrive. Yet another benefit is the ability to interpret and label the learned representations. In some aspects, the dimensions of the learned representations correspond to phrases, titles, and text pulled directly from text-bearing entities, making the representations easier to interpret and summarize compared to other embedding-based methods.

### Example Embodiments

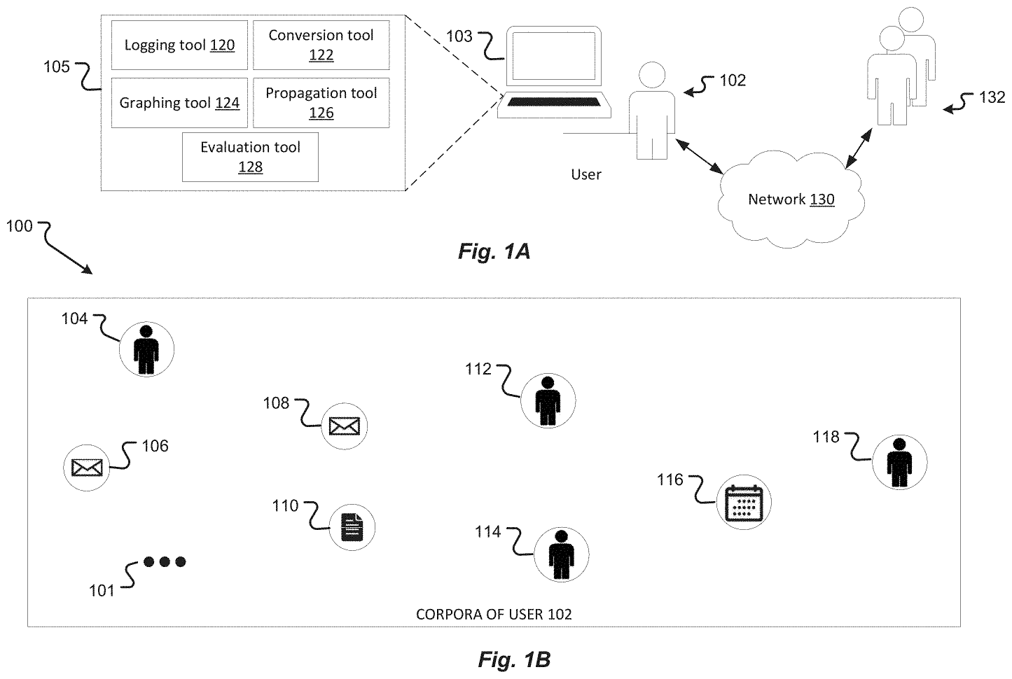

A system automatic discovery of users' high-level “activities” (projects, tasks) from the low-level entities in their corpora as shown in FIGS. 1-7.

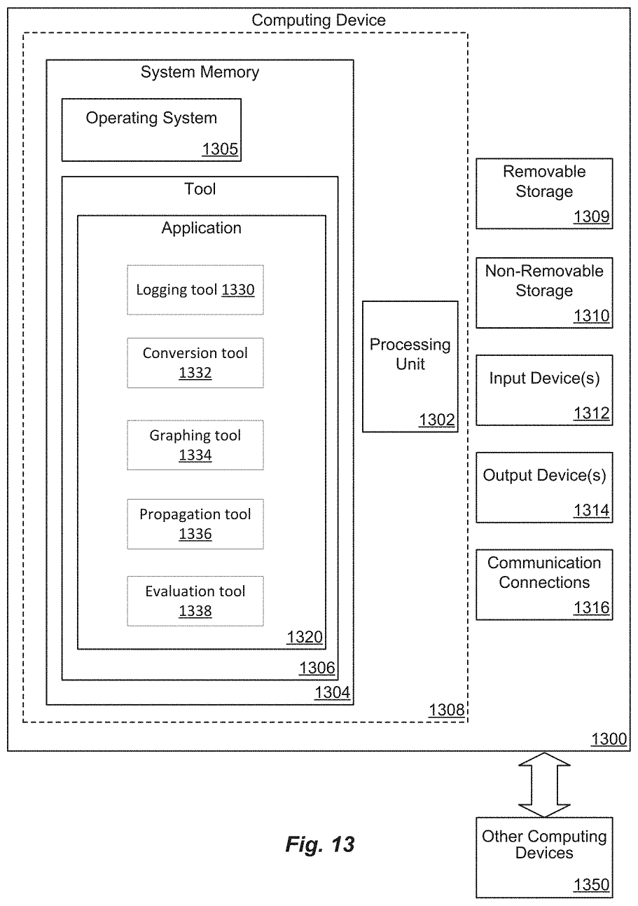

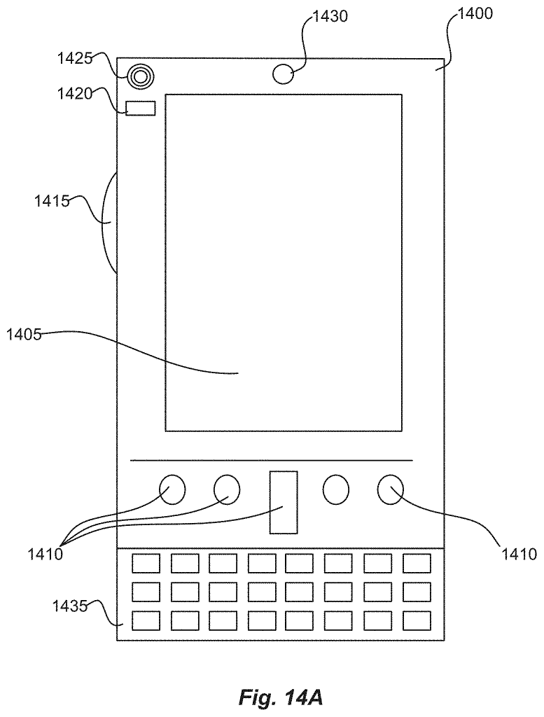

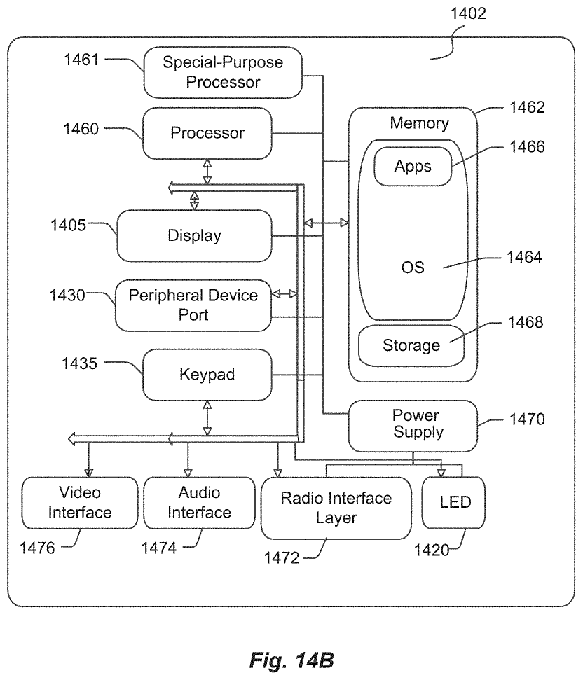

FIG. 1A illustrates a user 102's local computing device or system 103. System 103 may be any type of computer system or application and can include any hardware, software, or combination of hardware and software associated with a processor of the system 103, as described herein in conjunction with FIGS. 13, 14A, and 14B. System 103 may encompass more than one computing device. In at least some configurations, the system 103 is software executing on a server (not shown) in or connected to a network 130. The network 130 can be any type of local area network (LAN), wide area network (WAN), wireless LAN (WLAN), the Internet, etc. Communications between the user 102's system 103 and the network 130 can be conducted using any protocol or standard. Other users 132 may be connected to user 102 through network 130.

System 103 has an entity-activity relationship application 105 installed thereon that is capable of performing the systems and methods described herein.

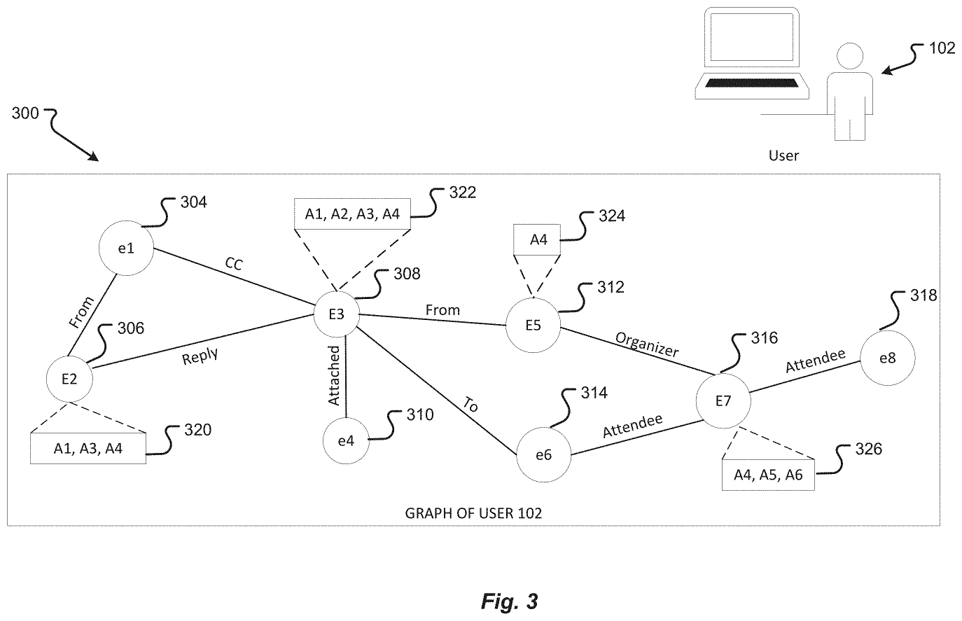

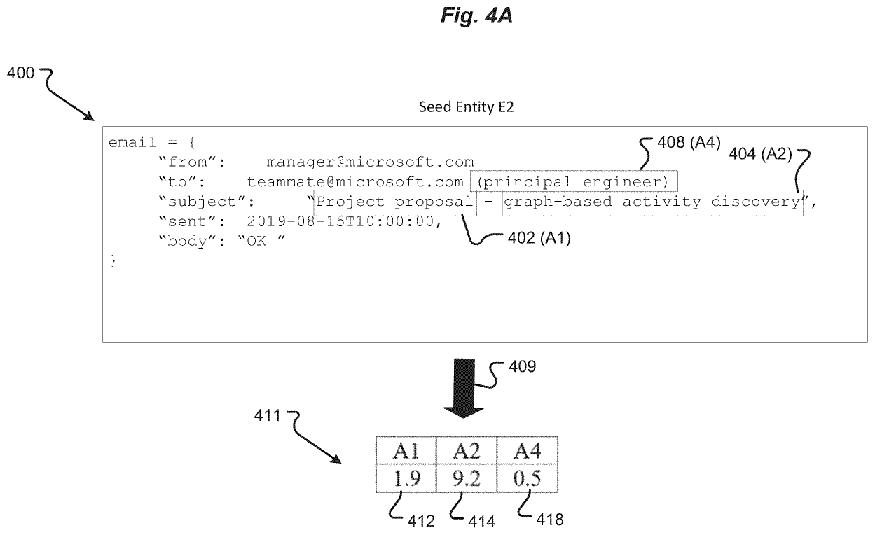

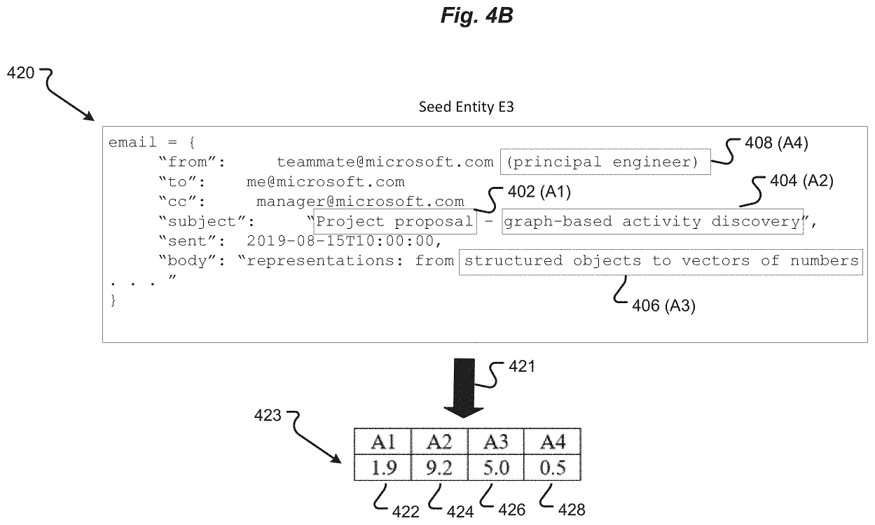

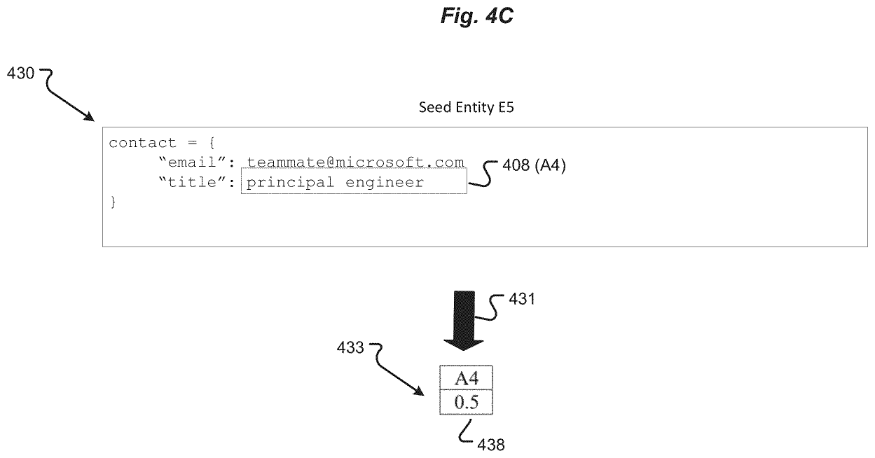

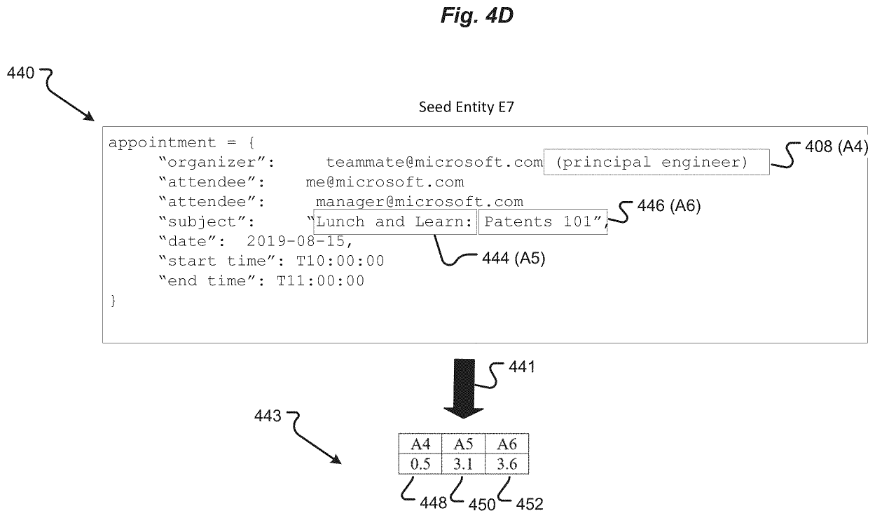

In aspects of the present disclosure, a logging tool 120 indexes information items, such as mails and calendar appointments, for user 102, and further records the user 102's interactions with these and other information items on the system 103. In aspects, the logging metadata of these items include, e.g., the people associated with an email, the textual content of a tile, when an individual clicked on a meeting, how long she focused on a web page, etc. In some aspects, the logging tool 120 logs information items previously downloaded to the system 103 and logs are stored locally on system 103 to preserve the privacy of the user 102's information items. In other aspects, the logging tool 120 logs information items that are stored in a remote account, such as a cloud based account. The logging tool 120 may also automatically extract attributes from one or more of the information items, if possible and/or available. Attributes relate to activities with which user 102 is associated and may include short pieces of text, for example key phrases from email subject lines or email bodies as described in more detail with reference to FIGS. 3 and 4A-4D.

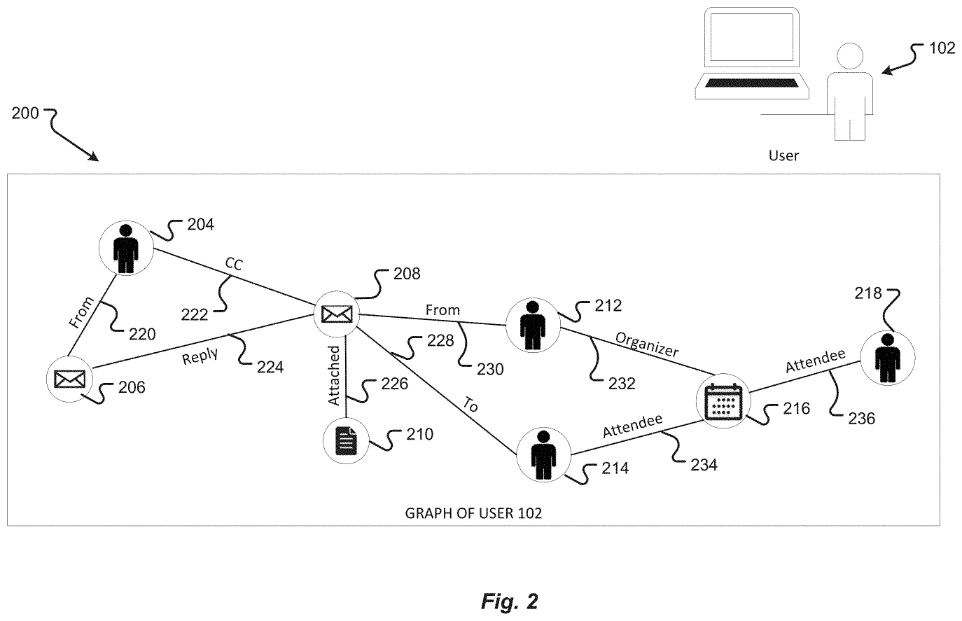

In aspects of the present disclosure, a graphing tool 124 models user 102's information items (e.g., corpora) as a “graph”, for example by connecting people to meetings and emails based on the attendee and recipient lists, respectively. Each item of information (e.g., emails, files, appointments, web searches, contacts) is a node or entity in the graph and the nodes are connected together by edges their relationships to each other) as described in more detail with reference to FIG. 2.

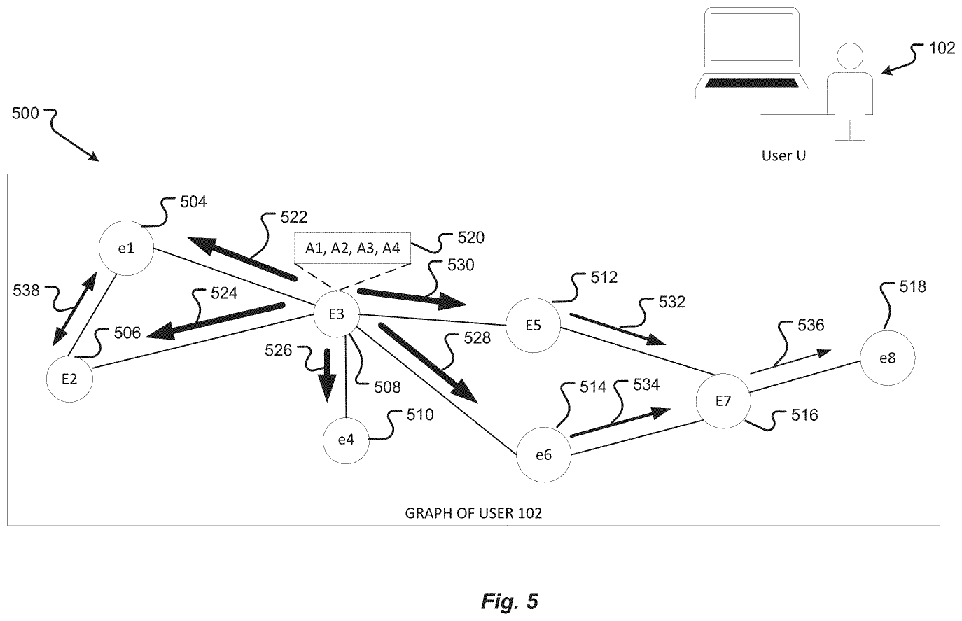

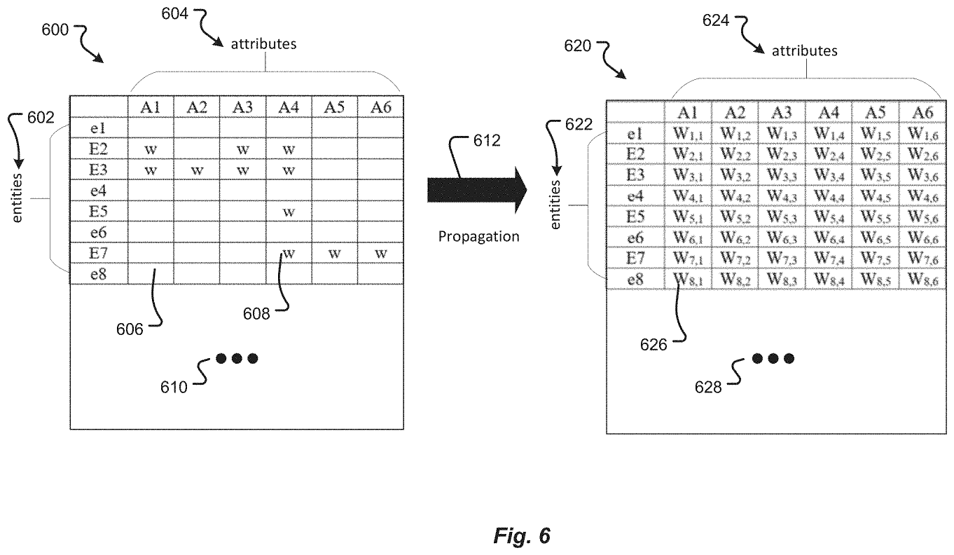

A conversion tool 122 converts the extracted attributes to standardized representations, such as vectors of numbers as described in more detail with reference to FIGS. 4A-4D. This allows the attributes to be propagated across the graph and then used to compare the degree of relatedness of one information item to another as described in more detail with reference to FIGS. 5-6.

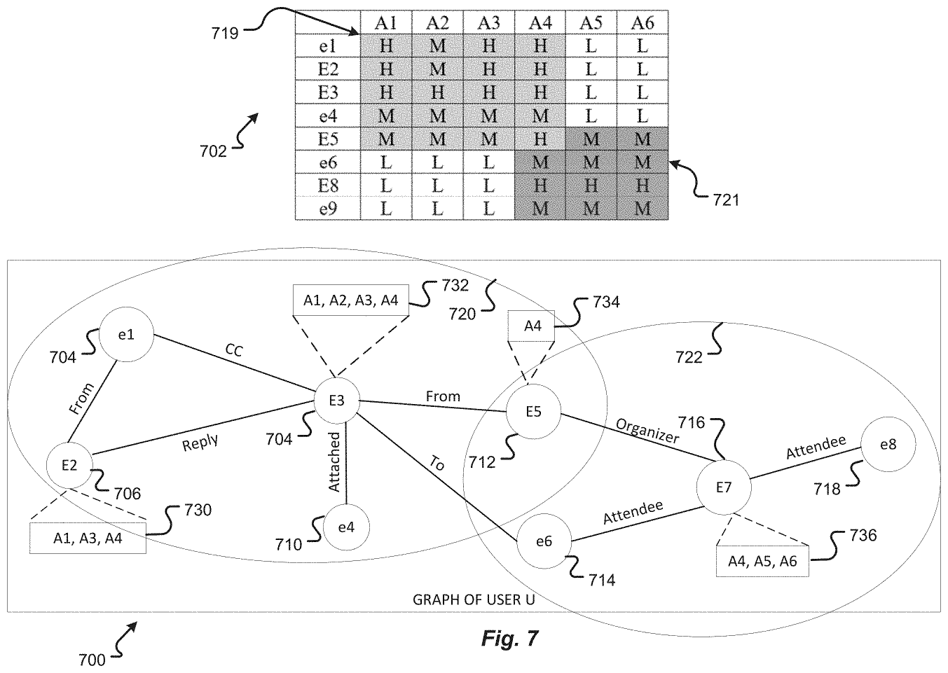

A propagation tool 126 propagates the attributes or labels across the graph's structure. This results in a representation space of entities mapped against attributes, where each row is a representation of an entity, each attribute is represented in a column, and each entry (e.g., intersection of a row and column) describes the degree to which an entity is associated with an attribute as shown in FIGS. 6 and 7. In aspects, the representation space is a matrix.

An evaluation tool 128 uses the representation to associate the information items with higher level activities through various applications such as searches and/or clustering as described in FIG. 7.

FIG. 1B illustrates the corpora 100 of user 102. The corpora may include any number of information items 104-118, which will also be referred to herein as nodes and/or entities. Although a limited number of information items are illustrated, the corpora may include any number and type of information items as illustrated by ellipses 101. These information items may be any type of information, including a structured entity that is sent to, received from, or associated with the user 102 and may include, without limitation, emails, files, appointments, web searches, contacts. Entities 104, 112, 114, and 118 are contacts of User 102. Entities 106 and 108 are emails sent or received by user 102. Entity 116 is a calendar appointment for user 102. The corpora 100 is evolving as new entities are added and deleted, such that FIG. 1B shows a snapshot in time of user 102's corpora.

FIG. 2 illustrates a graph 200 for user 102 that is constructed from the corpora 100 from FIG. 1. An entity (node) in the graph 200 has an associated type, such as Email, Calendar Appointment, Web Document, File, or Contact, and may be associated with additional temporal and textual features, for example email sent times, subject lines, etc. An edge in the graph encodes a semantically meaningful relationship between entities. In aspects, there are the following edge relations: (1) Contact-Email, connecting people to emails that they sent, received, or were CC'ed on; (2) Contact-Calendar Appointment, connecting people to calendar appointments that they organized or attended; (3-4) Email-Web Document and Calendar Appointment-Web Document, connecting emails and appointments to web documents if the participant accessed the document immediately after reading the email or appointment (e.g., when clicking a link in the email body); (5-6) Email-File and Calendar Appointment-File, connecting emails and appointments to desktop files if the participant accessed the document immediately after reading the email or appointment; (7) Email-Email, connecting pairs of emails that appeared consecutively in a thread (i.e., replies). For example, the graph 202 includes edges 220-236 that indicate the relationships between the entities 204-218. Entity 212 sent email 208 as indicated by edge 230 to entity 214 as indicated by edge 228. Entity 204 was cc'd on email 208 as indicated by edge 222. Email 206 was sent from entity 204 as indicated by edge 220 and in reply to email 208 as indicated by edge 224. Document 210 is an attachment to email 208 as indicated by edge 226. Entity 212 organized calendar appointment 216 as indicated by edge 232 and entities 214 and 218 are attendees of this meeting as indicated by edges 234 and 236. The graph does not include user 102 who owns the data.

FIG. 3 illustrates a graph 300 for user 102 that is constructed from the corpora 100 from FIG. 1. Icons indicating the type of entity have been replaced with the letter “e”. Some or all of the entities in the graph 300 may be associated with attributes. These are called “seed entities” and are represented with an upper case “E.” Non-seed entities, or entities that do not yet have attributes associated with them, for whatever reason, are shown with a lower case “e.” graph 300 includes seed entities E2 306, E3 308, E5 312, and E7 316.

More specifically, seed entities are associated with “activity specific” attributes, which are textual, temporal, or other attributes indicative of activities. Any type of textual cue may be an attribute and different types of entities may have different types of attributes. For example, a contact may have textual attributes including name, email address, and alias. An email may have attributes including the sender, receivers, and noun phrases associated with its various fields, included in the subject and body of the email. Noun phrase frequencies and latent topic memberships are considered to be particularly effective attributes for identifying relatedness between entities and further associating entities with activities. Noun phrases often directly correspond to project, task, or goal names, whereas latent topics capture semantic relatedness among groups of documents. The use of noun phrases can produce fully human-interpretable representations because they correspond to natural language. Activity labels are another example of attributes, if available.

For example, seed entity E2 406 includes three attributes 420 comprising A1, A3, and A4. Seed entity E3 408 has four attributes 422 comprising A1 A2, A3, and A4 as shown in FIG. 3. Seed entity E5 412 includes attribute 424 comprising one attribute A4. Seed entity E7 416 includes three attributes 426 comprising A4, A5, and A6.

As discussed above in FIG. 1A, activity related attributes are automatically extracted from the entities in graph 300. Such extraction is unsupervised, meaning little or no human intervention is required. However, the systems and methods may also be used with user provided attributes or labels. For example, a document or email may be tagged by a user with a noun-phrase or filed in a named folder. The tag or folder name can be used as attributes along with the automatically extracted attributes.

FIGS. 4A-4D show the seed entities from FIG. 3, respectively. The seed entities E2, E3, E5, and E7 have one or more attributes that may be automatically discovered using the systems and methods described herein. Seed entities may be structured objects, but do not have to be. These objects are converted to standardized representations such as vectors of numbers associated with their attributes as shown in FIGS. 4A-4D.

There are many possible ways to convert the attributes in the seed objects to standardized representations of attributes. For example, if all possible attributes in a graph are known, each entry in each row can be assigned with a 1 or a 0 for each attribute, indicating if the attribute is present or not for the entity associated with the entry. In another aspect, the standardized representation can be the frequency of occurrence of the attribute in the seed entity. In yet another aspect, weightings like term frequency-inverse document frequency (TF-IDF) which count term frequency (TF), but penalize common words that appear in many documents entities (IDF) could be used. In yet another aspect, the standardization could be done by BM25, which normalizes for document length among other things. Further, “weight” can have different meanings depending on the attribute in question. For example, if the attributes are textual tokens, weights can correspond to the number of times each token appeared in the entity (e.g., a file or email). The weights can also come from machine learning methods like topic discovery, in which case they correspond to the “amount” that entity X belongs to topic Y. Finally, the weights can be set by users, with a higher weight meaning that the entity in question belongs more strongly to a given activity.

FIG. 4A illustrates seed entity E2 400, which is an email type of entity (shown as E2 306 in FIG. 3). Noun phrase 402 “Project Proposal” is a first attribute A1 for entity 400. Noun phrase 404 “graph-based activity discovery” is a second attribute A2 for entity 400. Contact title 408 is a third attribute A4 for entity 400. These attributes are converted to vectors of numbers 411 as shown by arrow 409. In this way, attribute A1 402 is associated with a weight (“w”) 412. of 1.9, attribute A2 404 is associated with weight (w) 414 of 9.2, and attribute A4 is associated with weight (w) 418 of 0.5.

FIG. 4B illustrates seed entity E3 420, which is an email type of entity (shown as E3 308 in FIG. 3). Noun phrase 402 “Project Proposal” is a first attribute A1 for entity 420. Noun phrase 404 “graph-based activity discovery” is a second attribute A2 for entity 420. Noun phrase 406 “structured objects to vectors of numbers” is a third attribute 43 for entity 420. Contact title 408 is a fourth attribute A4 for entity 420. These attributes are converted to vectors of numbers 423 as shown by arrow 421. In this way, attribute A1 402 is associated with a weight (“w”) 412 of 1.9, attribute A2 404 is associated with weight (w) 414 of 9.2, attribute A2 404 is associated with weight (w) 416 of 5.0, and attribute A4 is associated with weight (w) 418 of 0.5.

FIG. 4C illustrates seed entity E5 430, which is a contact type of entity (shown as E5 312 in FIG. 3). Contact title 408 is an attribute A4 for entity 430. This attribute is converted to a vector number 433 as shown by arrow 431. In this way, attribute A4 is associated with weight (w) 438 of 0.5.

FIG. 4D illustrates seed entity E7 440, which is an appointment type of entity (shown as E7 316 in FIG. 3). Contact title 408 is an attribute A4 for entity 440. Noun phrase 444 “Lunch and Learn” is a second attribute A5 for entity 440. Noun phrase 446 “Patents 101” is a third attribute A6 for entity 440. These attributes are converted to vectors of numbers 443 as shown by arrow 441. In this way, attribute A4 408 is associated with a weight (w) 448 of 0.5, attribute A5 444 is associated with weight (w) 450 of 3.1, and attribute A6 446 is associated with weight (w) 452 of 3.6.

FIG. 5 illustrates a graph 500 for user 102 where the attributes for a seed entity are illustrated, which are designated by upper case “E”. Non-seed entities are designated by lower case “e”. Entities E2 (entity 401 in FIG. 4A), E3 (entity 420 in FIG. 4B), E5 (entity 430 in FIG. 4C), and E7 (entity 440 in FIG. 4C) are seed entities with attributes shown in FIGS. 3 and 4A-4D. In aspects, the attributes for each entity are diffused or propagated through the graph 500. The propagation process yields similar representations for entities that are closely connected in the graph 500 and/or share similar attributes.

While one or more of the attributes of a seed entity are propagated or diffused to other entities (seed or not) in the graph 500, for clarity of illustration FIG. 5 shows the propagation of the attributes for only one seed entity E3 508. Arrows 522, 524, 526, 528, and 530 show the propagation of attributes A1, A2, A3, A4 520 from seed entity E3 508 to its directly connected entities e1 504, E2 506, e4 510, e7 514, and E5 512, respectively. Arrows 532 and 534 show that the attributes A1, A2, A3, A4 520 are propagated from entity e5 512 to entity E7 516 and from entity e6 514 to E7 516, respectively. Arrow 536 shows the propagation process as attributes A1, A2, A3, A4 520 are diffused or propagated from entity E7 516 to entity e8 518.

As the attributes' weights (e.g. vector numbers) are propagated or diffused over the graph 500, their weights lessen such that the attributes have a larger impact on entities or nodes closer to the initiating seed node than they do on entities or nodes that are farther away from the initiating seed node. This is shown by the width of the propagation arrows in FIG. 5. Arrows 522-530 are the widest because they represent propagation to an entity directly connected to the initiating seed entity E3 508. Arrows 532 and 534 are narrower than arrows 522-530 because they represent propagation from an entity that is one level away from the initiating seed entity E3 508. Arrow 536 is narrower still than arrows 532 and 534 because it is two nodes or two operations away from the initiating seed entity E3 508. Thus, the impact of the propagation process of attributes A1, A2, A3, and A4 from seed entity E3 508 is greatest on entities e1 504, E2 506, e4 510, e6 514, and E5 512 and smallest on entity e9 518.

Although not shown, a similar propagation process is performed for seed entities E2 506, E5, 512, and E8 516 to one or more other entities in graph 500.

FIG. 6 shows a matrix 600 or representation of attributes for the entities in the graph (such as graphs 200, 300, and 500 shown in FIGS. 1, 2, 3 and 5) before propagation and a matrix 620 after propagation, where a lower case “w” represents an attribute weight before propagation and an upper case “W” represents an attribute weight after propagation.

Matrix 600 has a number of rows representing the entities 602 in the graph. Matrix 600 also has a number of columns representing the attributes identified in the graph. There may be any number of entities and/or attributes as illustrated by ellipses 610. The intersection of a row 602 and a column 604 (e.g., an entry) represents the weight of a particular attribute for a particular entity. For example, entry 606 of matrix 600 is empty because entity e9 does not have attribute A1. As another example, cell 608 indicates that there is a weight (w) for attribute A4 on entity E8. In FIG. 6, w is a number that is greater than zero and a blank cell represents a zero weight.

Matrix 620 illustrates matrix 600 after propagation as shown by arrow 612. In matrix 620, entities 622 mapped against attributes 624, where each row in the matrix is a representation of an entity, an attribute is represented in a column, and each entry (e.g., intersection of a row and column) in the matrix encodes a real-value number describing the degree to which entity or node is associated with label or attribute. Because the attributes from the seed entities have been propagated or diffused across the entire graph, each entry or cell in the matrix 620 has a weight W, which comprises a combination of weights w from matrix 600 after propagation. Each W may be a different number as represented by the subscript number to its left. For example, entry 626 describes the degree or weight to which entity e8 is associated with attribute A1. Before propagation, this value was zero as shown in entry 606 in matrix 600. However, this entry is no longer zero because the weight of attribute A1 was diffused from entities E2 and E3 as shown in FIG. 5. The diffused values of attributes A1 from entities E2 and E3 are combined to create weight W_{8,1} 626 in the matrix 620. In this way, the matrix or representation 620 presents all entities and attributes in a similar way with real numbers that may be used to compare the relatedness of one entity to another.

Matrix 620 may also be used to rank search results identifying entities in order of relatedness to a particular entity. Each entity's representation is a row of the matrix. Given a query entity Q with its corresponding vector representation, all other entity representations' distance/similarity to Q's representation can be computed using vector similarity measures like Euclidean distance or cosine similarity. These entities can then be ranked according to their vector distance/similarity from Q. For example, the query is treated as if it is a node in the graph (usually disconnected from anything else). In this case, the words or noun phrases are extracted from query as described above. The query is assigned a standardized representation as if a new seed entity was created prior to propagation. A loss function ensures that the graph entity representations do not wander too far from where they started, so this query representation will be close in the vector space to similar entities in the graph. Then the results (e.g., graph entities) are sorted from closest to furthest from the query.

FIG. 7 illustrates how clustering in the representation, such as matrix 620 in FIG. 6, may be used to automatically discover which low-level entities are related to which high level activities. Matrix 702 is a representation based on graph 700. Graph 700 is based on the corpora 100 from FIG. 1 and constructed in the same as shown in FIGS. 2, 3, and 5. Matrix 702 includes entities from graph 700 that are mapped against attributes from graph 700, where each entity is a row in the matrix, each attribute is a column, and an entry in the matrix encodes a real-value number describing the degree to which entity or node is associated with label or attribute. Rather than using a real number for the degree of association, categories of H, M, and L are used. An entry of “H” represents a high weight or degree of association between the attribute and entity. An entry of “M” represents a medium weight or degree of association between the attribute and entity. An entry of “L” represents a low weight or degree of association between an attribute and entity. For example, any attribute that is associated with a seed entity has a value of H. This is shown by the entries of E3/A1, E3/A2, E3/A3, and E3/A4. In contrast, the entries for E3/A5 and E3/A6 are low because attributes A5 and A6 were propagated from only one entity E7 716, which is two nodes away from E3 708. The entry of e1/A1 is high because attribute A1 was propagated to entity e1 704 from two directly connected entities E2 706 and E3 708. The entry of e1/A2 is medium because attribute A1 was propagated directly to entity e1 704 from only one directly connected entity E3 708. The entry e1/A5 is low because it was propagated from only one entity E7 716, which is three nodes away from entity e1 704.

Converting the heterogeneous structural entities into vectors of numbers/weights for attributes in seed entities and then propagating the weights across the graph creates a matrix or representation of homogenous weights that may be used to analyze the relatedness of such heterogeneous entities to each other. In other words, the representation space allows the heterogeneous entities to be directly compared.

For example, matrix 702 has two cluster patterns where M and H weights are grouped together. The first cluster pattern 719 shows that entities e1, E2, E3, e4, and E5 are related by attributes A1-A4. This relationship is shown by circle 720 in graph 700. The second cluster pattern 721 shows that entities ES, e6, and e7 are related by attributes A4-A6. This relationship is shown by circle 722 in graph 700. From this data, it can be accurately inferred that entities e1, E2, E3, e4, and E5 are related to one high level activity and entities E5, e6, E7, and e8 are related to another high level activity.

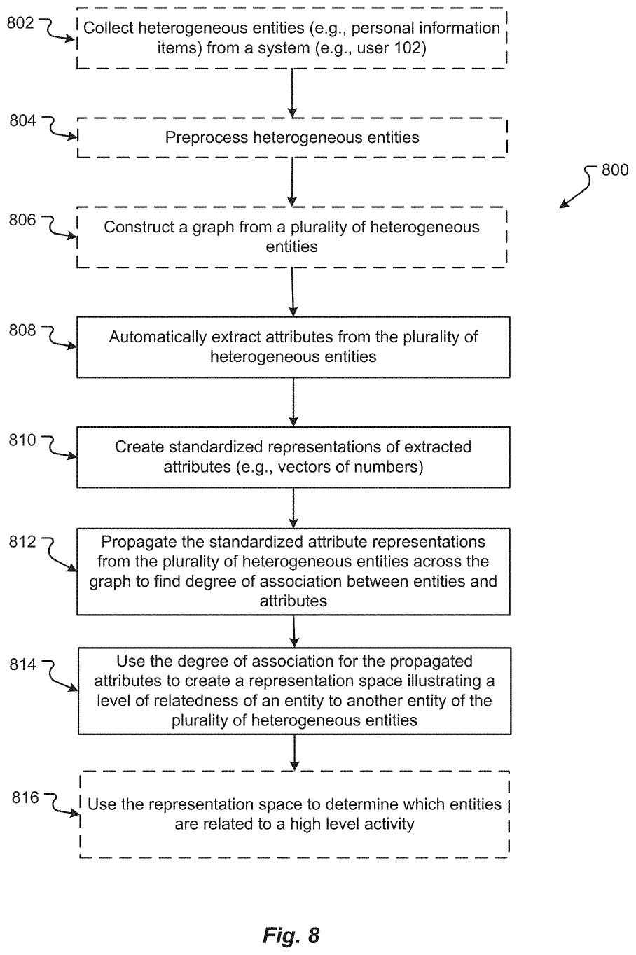

FIG. 8 illustrates an exemplary method 800 for determining the degree of relatedness between heterogeneous entities from a graph such as graph 300 shown in FIG. 3. Method 800 may be conducted on a user's local computer system or on a server system for a user. Method 800 may be used for a single user or a group of users. A general order for the operations of the method 800 is shown in FIG. 8. Generally, the method 800 starts with a start operation 802 and ends with an end operation 818. The method 800 can include more or fewer operations or can arrange the order of the operations differently than those shown in FIG. 8. The method 800 can be executed as a set of computer-executable instructions executed by a computer system and encoded or stored on a computer readable medium. Further, the method 800 can be performed by gates or circuits associated with a processor, an application specific integrated circuit (ASIC), a field programmable gate array (FPGA), a system-on-chip (SOC), or other hardware device. Hereinafter, the method 800 shall be explained with reference to the systems, components, devices, tools, software, data structures, user interfaces, methods, etc. described in conjunction with FIGS. 1-7 and 9-14B.

Operations 802, 804, and 806 of collecting heterogeneous information items, preprocessing them and building a graph are optional aspects of this disclosure. In aspects, method 800 may begin at operation 808 by leveraging an existing graph.

In aspects, method 800 begins with optional operation 802, where the corpora (e.g., heterogeneous entities or information items), such as emails and calendar appointments, from a user's system are collected and the user's interactions with these and other information items are recorded on the local computer system. The entities are referred to as “heterogeneous” because they may contain different types of information, including emails, calendar appointments, web searches, files, contacts, etc. Metadata of these items include, without limitation, the people associated with an email, the textual content of a file, when an individual clicked on a meeting, how long she focused on a web page, etc. In aspects, this information may be logged using the logging application discussed in connection with FIG. 1A. In other aspects, other types of software may be used to collect the information items such as an email client program. Optionally, to promote privacy, the information is stored locally, no information is uploaded to the cloud, and evaluation scripts using these logs are run locally on the user's computer system. However, in other aspects, the logs and other information may be stored in user's private cloud accounts and the evaluation scripts may be run remotely and stored in the cloud.

Optionally, at operation 804 the corpora may be preprocessed to discard less relevant information such as placeholder emails/appointments (e.g., “automatic reply”), emails/appointments from senders that the participant did not contact, emails without the participant on the To, From, or CC lines, emails that the participant only sent to herself, and, following, emails/appointments with over 10 recipients. To capture a rough notion of “importance”, in aspects only web documents/files that the participant dwelled on for a certain period of time (e.g., 10 consecutive seconds) are retained.

At optional operation 806, a graph (such as graphs 200 and 300 shown in FIGS. 2 and 3) is constructed for the heterogeneous entities collected in operation 802. In some aspects, the graph may already exist and the method 800 may utilize the preexisting graph and begin at operation 808. As discussed in connection with FIG. 2, each entity (e.g., node) in the graph has an associated type, such as Email, Calendar Appointment, or Contact, and may be associated with additional temporal and textual features, for example email sent times, subject lines, etc. The graph is constructed by adding edges between the entities. In certain aspects, each edge in the graph encodes a semantically meaningful relationship between entities. For example, an edge connecting a Calendar Appointment to a Contact might signify that the appointment was organized or attended by that person.

At operation 808, attributes are automatically extracted from one or more of the entities. As discussed in connection with FIGS. 3 and 4A-4D, attributes may be textual, temporal, or otherwise indicative of activities. For example, as textual attributes, noun phrases are extracted from email/appointment subject lines and document/file titles. In aspects, general and domain-specific stop words (e.g., filename extensions like “pdf”, email abbreviations like “fwd”) are removed as are phrases that often appear in search results (“Google Search”). In aspects, the degrees of association between attributes and entities are stored and may be organized in a matrix such as matrix 600 shown in FIG. 6. A key or legend may track which attribute is associated with which column. In aspects, not all entities will have associated attributes. The entities with attributes are referred to herein as “seed entities.” Although operation 808 is illustrated as occurring after the construction of the graph at operation 806, it could just as easily occur before the creation of the graph at operation 806.

At operation 810, the attributes from the entities within the graph, which are structured entities, are converted to a vector of numbers as shown and discussed in connection with in FIGS. 4A-4D.

At operation 812, one or more attributes from one or more of the seed entities is propagated or diffused across the entire graph of the user as shown and discussed in connection with FIG. 5. The farther an attribute weight is propagated away from its initiating seed node, the smaller its weight or impact will be on node to which it is propagated. Said another way, through the propagation process, attributes have the highest impact on nodes closest to the initiating node.

At operation 814, the propagated attributes are used to encode a degree to which an attribute is associated with an entity as shown in FIGS. 6 and 7. The degree may be a number or category or other way of measuring association.

At operation 816, the degrees of association from the propagated attributes are used to create a representation space illustrating a level of relatedness (e.g., how related or not related) one or more entities is to one or more other entities of the plurality of heterogeneous entities as shown in FIGS. 6 and 7.

At operation 818, the representation space may be used to determine which entities are related to a high level activity through clustering and/or classification as shown in FIG. 7.

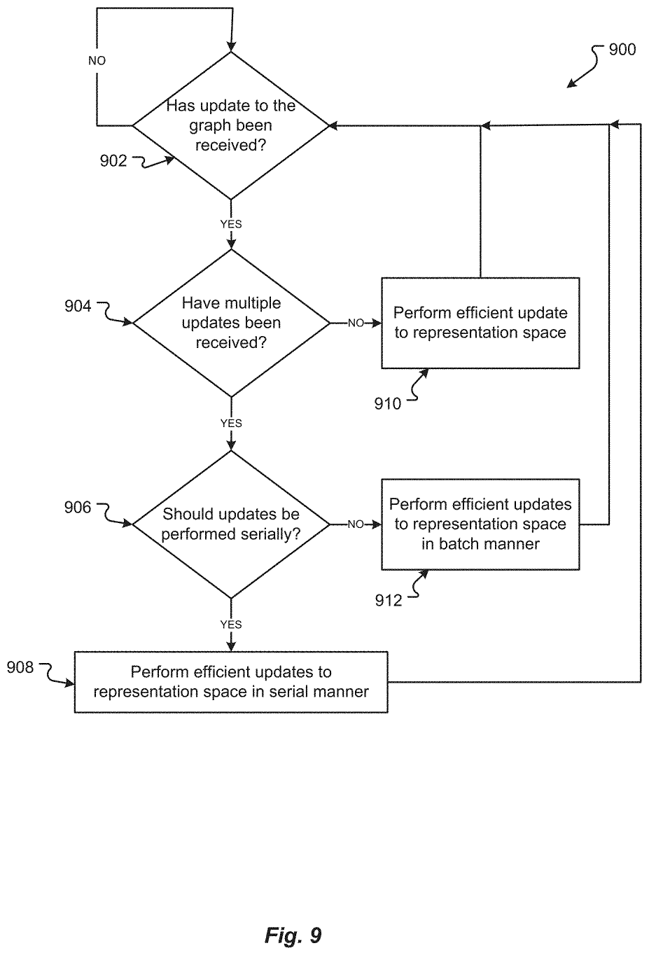

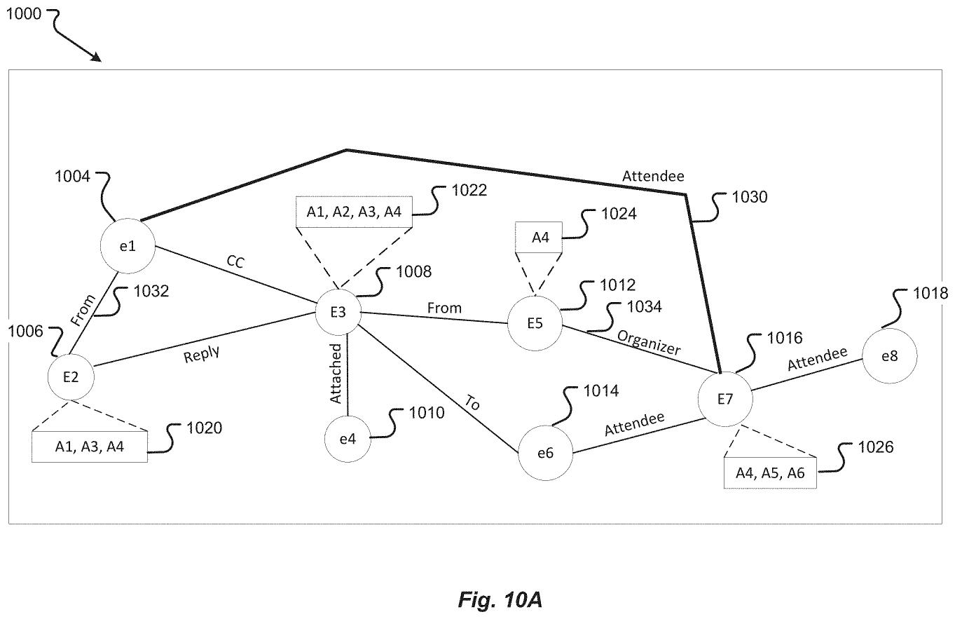

A method 900 for updating the representation space (such as matrix 620 and matrix 702) as new information arrives is shown in FIG. 9. Method 900 may be conducted on a user's local computer system or on a server system for a user. A general order for the operations of the method 900 is shown in FIG. 9. Generally, the method 900 starts with a start operation 902 and ends with an end operation 919. The method 900 can include more or fewer operations or can arrange the order of the operations differently than those shown in FIG. 9. The method 900 can be executed as a set of computer-executable instructions executed by a computer system and encoded or stored on a computer readable medium. Further, the method 900 can be performed by gates or circuits associated with a processor, an application specific integrated circuit (ASIC), a field programmable gate array (FPGA), a system-on-chip (SOC), or other hardware device. Hereinafter, the method 900 shall be explained with reference to the systems, components, devices, tools, software, data structures, user interfaces, methods, etc. described in conjunction with FIGS. 1-8 and 10A-14B.

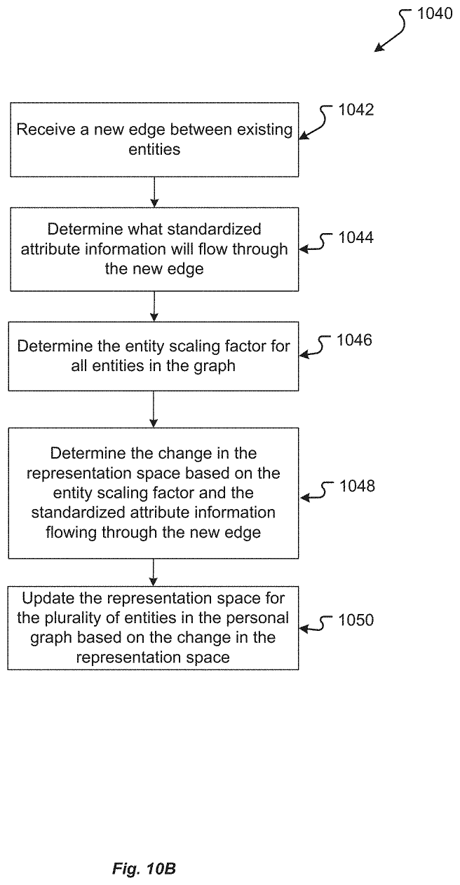

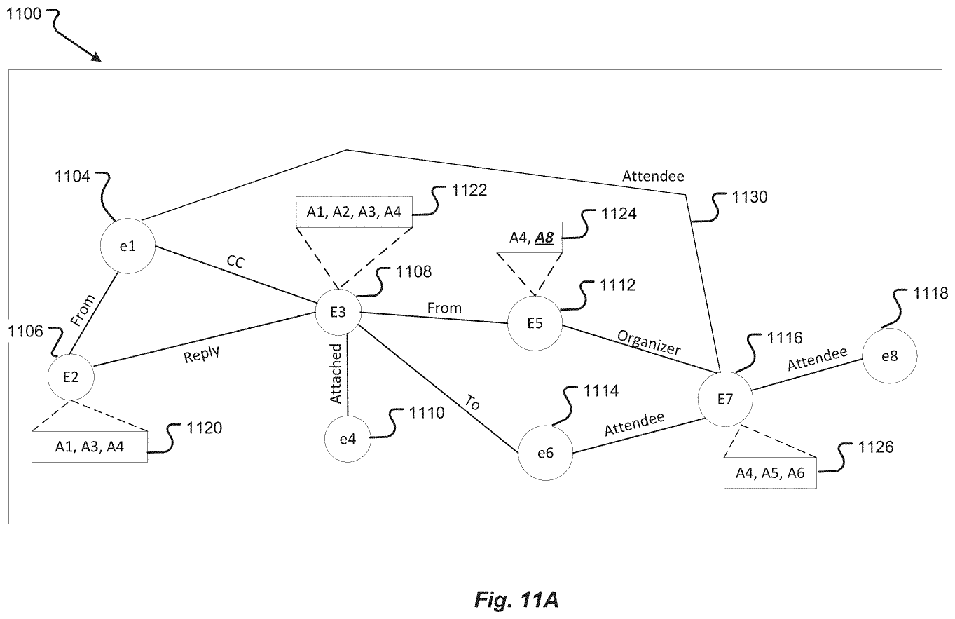

At operation 902 a determination is made as to whether an update to the graph (such as graphs 200 or 300 in FIGS. 2 and 3) has been received. Updates may include a new edge between existing entities, one or more new attributes for existing entities, and/or one or more new entities. New entities may or may not be connected to the graph. New entities may or may not include existing attributes and/or new attributes. Each of these scenarios is discussed in detail with respect to FIGS. 10A, 10B (new edge), 11A, 11B (new attribute), and 12A-12C (new entity). A benefit of the present disclosure is that it is capable of efficiently updating the representation space (e.g., matrix) when a new information is received by a user or group of users. The novel methods of efficiently updating the graph are much faster and less costly than creating a new representation when a new update to the graph is received. As such, the representation space may be updated when an update is received to the graph. If an update has not been received (NO at operation 902), the method loops back to operation 902 to wait for a new update.

If an update has been received (YES at operation 902), the method 900 proceeds to operation 904 to determine if multiple updates have been received. If only one update has been received (NO at operation 904), the method 900 proceeds to operation 910 to perform an efficient update to the representation space based on the received update. The method 900 then loops back to operation 902 to determine if any additional updates to the graph have been received.

If multiple updates have been received (YES at operation 904), the method 900 proceeds to operation 906 to determine whether the multiple updates should be processed serially, e.g., one after another. If YES at operation 906, the method 900 proceeds to operation 908 and the efficient update procedure is performed on the multiple updates in a serial manner. When completed, the method 900 then loops back to operation 902 to determine if any additional updates to the graph have been received. If multiple updates should be performed at the same time (NO at operation 906), the method 900 proceeds to operation 912 where the efficient update methods are performed on all updates at the same time or in a batch operation. When completed, the method 900 then loops back to operation 902 to determine if any additional updates to the graph have been received.

FIG. 10A illustrates a graph 1000 for user 102 that is constructed from the corpora 102 from FIG. 1 and is identical to FIG. 3 except that it has a new edge that did not exist at the point in time that graph 300 was captured. Like the graph 300 in FIG. 3, graph 1000 has the same entities e1-e9 1004-1019. Like graph 300, the seed entities E2 1006, E3 1009, E5 1012, and E7 1016 have the same attributes 1020-1026, respectively. However, an edge 1030 has been added between node E7 1016, which is a calendar appointment type entity, and e1 1004, which is a contact type entity, indicating that entity e1 1004 will be an attendee for the appointment represented by entity E7 1016. However, the representation space (e.g., matrix 620 from FIG. 6) does not need to be entirely re-calculated.

When a new edge is added between current entities with no new attributes, one or more of the existing attributes will flow through the new edge either directly from the entities to which the new edge is connected or indirectly from the other edges in the graph. So for example, one or more of the existing attributes A1-A6 will propagate through the new edge 1030 either directly and/or indirectly. Attributes A4, A5, A6 1026 of entity E7 1026 will propagate directly through edge 1030 from E7 1026 to entity e1 1004. Attributes 1020 of entity E2 will propagate through the new edge 1030 via existing edge 1032 between E2 1006 and e1 1004. Attribute A4 will also propagate through existing edge 1034 between entity E5 1012 to entity E7 1016.

In addition to the additional propagation of attributes through the new edge, this propagation will impact the weights or degrees of relatedness of one or more entities to one or more other entities in the graph. For example, entities e1 1004 and E7 1016 have become more related because of the addition of new edge between then.

When a new edge is added between current entities with no new attributes, the matrix (\hat{X}) may be updated without fully calculating all the weights (W) of all the entries in the matrix, such as matrix 620 in FIG. 6. Rather, only the change in the matrix (in this case the effect of adding a new edge between existing entities) (ΔX) need be calculated. The new matrix representation is equal to the sum of the existing matrix and the change in the matrix, namely \hat{X}_{NEW}=\hat{X}+ΔX. The change in the matrix can be computed much more efficiently than computing the entire matrix from scratch as was shown from matrix 600 to matrix 620 in FIG. 6. The change in the matrix can be determined as the outer product of two vectors, u and v^{T} where u is a column vector with n entries—one for each entity and v is a column vector with p (number of attributes) and represents what attribute information will need to be updated for one or more entities. v represents the attribute information (standardized as shown in FIGS. 4A-4D) that will flow through the new edge and u represents the impact the information update will have on one or more entities once it reaches that entity through graph propagation due to the new edge.

u can be computed in a manner that is similar to computing the full matrix solution using Jacobi iteration, but this time it need be computed only for a single column vector (u) instead of for one or more attributes in existence. v can also be computed efficiently—the dominating factor is a matrix multiplication of \hat{X} which is O(np). Each entry of u, u[i] indicates how the update to entity i's representation will be scaled. Then for each entity i, v is scaled by −u[i] and added to the current representation of the entity. Mathematically, \hat{X}_{NEW}[i, :]=\hat{X}[i, :]−u[i]v.

FIG. 10B illustrates a method 1040 of updating the relatedness representation space for a graph based on the addition of a new edge between existing entities. Method 1040 may be conducted on a user's local computer system or on a server system for a user. A general order for the operations of the method 1000 is shown in FIG. 10B. Generally, the method 1040 starts with a start operation 1042 and ends with an end operation 1050. The method 1040 can include more or fewer operations or can arrange the order of the operations differently than those shown in FIG. 10A. The method 1040 can be executed as a set of computer-executable instructions executed by a computer system and encoded or stored on a computer readable medium. Further, the method 1040 can be performed by gates or circuits associated with a processor, an application specific integrated circuit (ASIC), a field programmable gate array (FPGA), a system-on-chip (SOC), or other hardware device. Hereinafter, the method 1040 shall be explained with reference to the systems, components, devices, tools, software, data structures, user interfaces, methods, etc. described in conjunction with FIGS. 1-10A and 11A-14B.

At operation 1042, a new edge is received between existing entities, such as new edge 1030 between node E7 1016 and e1 1004 in FIG. 10A.

At operation 1044, a determination is made as to what standardized attribute information will flow through the new edge. This is the variable v discussed in connection with FIG. 10A.

At operation 1046, a determination is made as to a scaling factor for the entities in the graph, namely how the propagation of the standardized attribute information that flows through the new edge will impact the weights of these attributes on one or more other entities in the graph. This is the variable u discussed in connection with FIG. 10A.

At operation 1048, a determination is made as to what has changed in the matrix, this is ΔX as discussed in connection with FIG. 10A and determined based on both what attribute information flows through the new edge (operation 1044) and the scaling factor that determines how this new flow impacts the weights of these attributes on one or more other entities in the graph (operation 1046).

At operation 1050, the representation space (e.g., the matrix) is updated by taking the original representation space and adding to it the change in the representation space determined in operation 1048. As discussed herein, method 1040 is a much more efficient way of accounting for the updated new edge to the graph in the relatedness matrix (e.g., matrix 620 in FIG. 6 and matrix 702 in FIG. 7) than calculating the whole matrix again from scratch for a graph with the new edge.

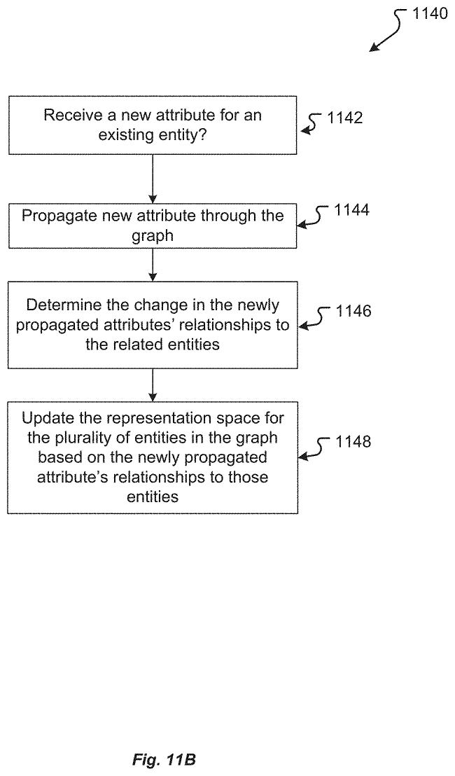

FIG. 11A illustrates a graph 1100 for user 102 that is constructed from the corpora 100 from FIG. 1 and is identical to FIG. 10A except that it has a new attribute A8 1124 for entity E5 1112 that did not exist at the point in time that graph 1000 was captured. Like the graph 900 in FIG. 9, graph 1100 has the same entities e1-e9 1104-1118 and same edges between the entities. Despite the new attribute A8 for entity E5, the representation space (e.g., matrix 620 from FIG. 6 or matrix 702 from FIG. 7) does not need to be entirely re-calculated. Rather, a Jacobi iteration can be done independently for the new attribute column for A8 (either for a fixed number of iterations or until some convergence guarantee) rather than for every column in the matrix because the adjacency matrix has not changed. In essence, a new column is added to the matrix (i.e., relatedness representation space for the graph) that relates to the new attribute A8.

FIG. 11B illustrates a method 1140 of updating the representation space for a graph based on the addition of a new attribute to an existing entity. Method 1140 may be conducted on a user's local computer system or on a server system for a user. A general order for the operations of the method 1100 is shown in FIG. 11B. Generally, the method 1140 starts with a start operation 1142 and ends with an end operation 1148. The method 1140 can include more or fewer operations or can arrange the order of the operations differently than those shown in FIG. 11A. The method 1140 can be executed as a set of computer-executable instructions executed by a computer system and encoded or stored on a computer readable medium. Further, the method 1140 can be performed by gates or circuits associated with a processor, an application specific integrated circuit (ASIC), a field programmable gate array (FPGA), a system-on-chip (SOC) or other hardware device. Hereinafter, the method 1140 shall be explained with reference to the systems, components, devices, tools, software, data structures, user interfaces, methods, etc. described in conjunction with FIGS. 1-11A and 12A-14B.

Method 1140 begins at operation 1142 where a new attribute is received for the graph (such as graph 1100 in FIG. 11). At operation 1144, a standardized representation of the new attribute is propagated through the graph as described herein, particularly with regard to FIG. 5. At operation 1146, a determination is made as to the change in the newly propagated attribute's degree of relatedness to each of the entities to which the new attribute was propagated. At operation 1148, the representation space (e.g., the matrix) is updated by taking the original representation space and adding to it the change in the representation determined in operation 1146. In effect, a column for the new attribute is added to the relatedness matrix without the need to recalculate all of the weights for all of the other attributes in the matrix. As such, method 1140 is a much more efficient way of accounting for the updated new attribute to the graph in the relatedness matrix than calculating the whole matrix again from scratch for a graph with the new attribute.

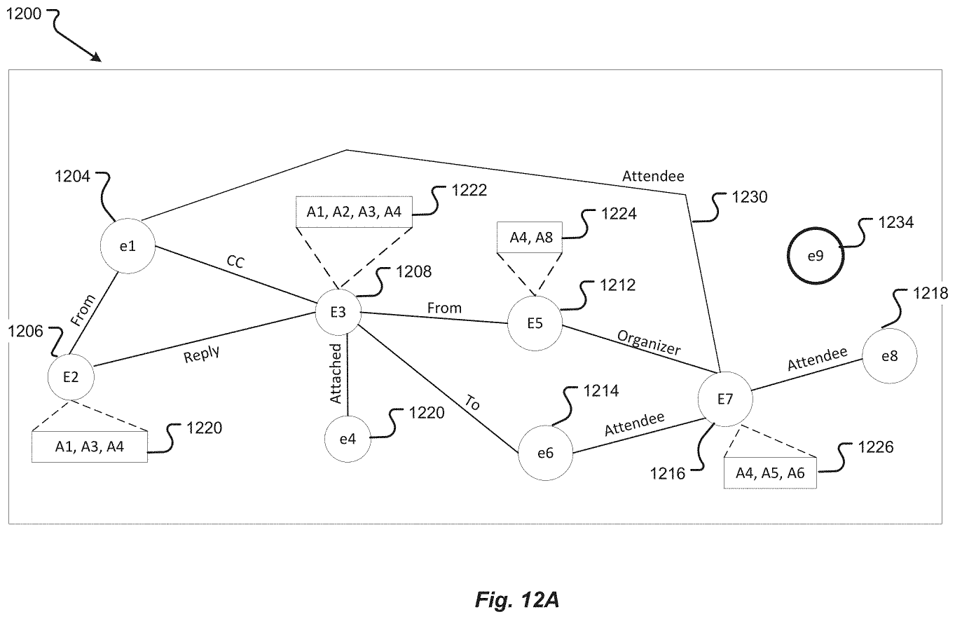

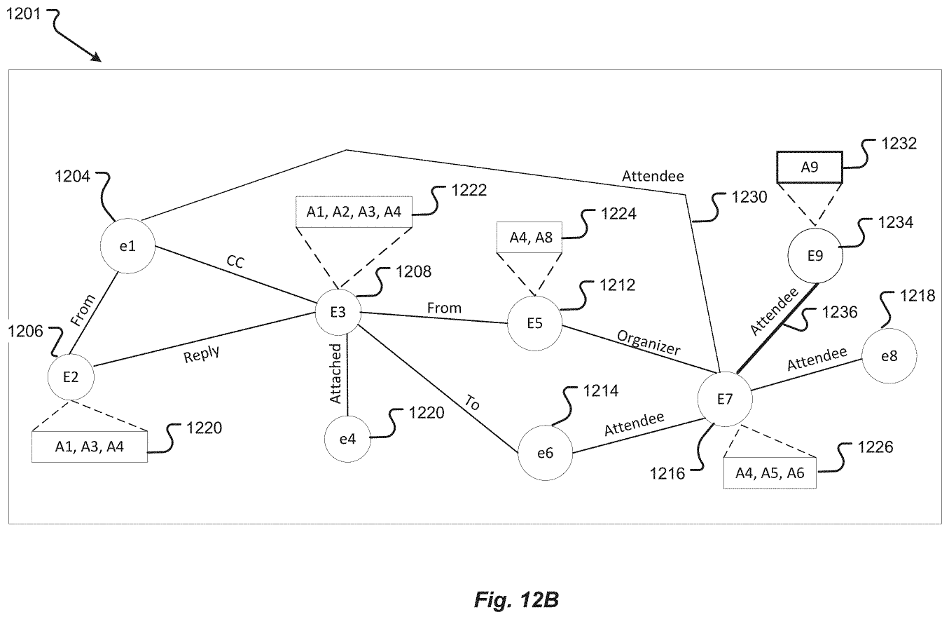

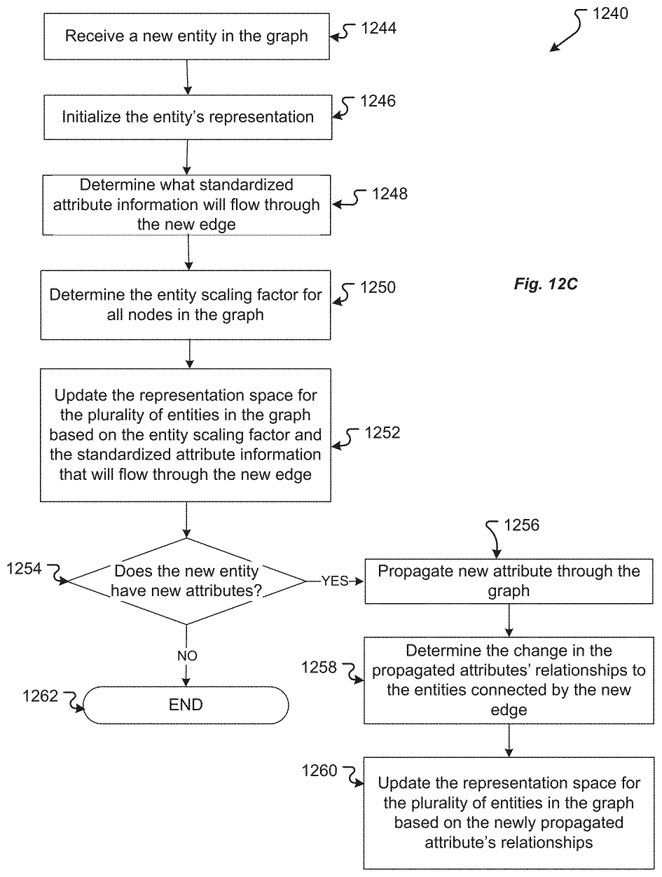

FIG. 12A illustrates a graph 1200 for user 102 that is constructed from the corpora 102 from FIG. 1 and is identical to FIG. 11A except that it has a new seed entity E9 1234 that did not exist at the point in time that graph 1100 was captured. Entity E9 1234 is not connected to the other entities e1-e9 1204-1219, which have the same edges between them. Because the entity E9 1234 is disconnected from the graph, graph propagation has no impact on either the new entity or previously observed entities. Thus no new calculation need be done. The matrix representation for FIG. 12A is the same as that shown in matrix 620 of FIG. 6 except that it has a new row for the new entity. The new row, however, doesn't require propagation with the other rows in the matrix. The result is the entity's representation is initialized based solely on itself \hat{X}[j, :]←X[j, :].

FIG. 12B illustrates a graph 1201 for user 102 that is constructed from the corpora 102 from FIG. 1 and is identical to FIG. 12A except that the new seed entity E9 1234 is now connected to entity E7 1216 via edge 1236 indicating that entity E9 is an attendee of calendar entity E7 1216. Further, entity E9 1234 has a new attribute A9 1232. The updated or new matrix representation may be determined through several steps. First, the new entity is added to the graph 1200 as a disconnected component as described with regard to FIG. 12A and ignoring the edge 1235 and any new attributes A9 1232. Next, the edge 1236 is added to connect the new entity and propagate its information ignoring the new attributes as described in FIGS. 9A and 9B. Third, for each new attribute, it is propagated across the across the graph using the method described with regard to FIGS. 11A and 11B.

FIG. 12C illustrates a method 1240 of updating the representation space for a graph based on the addition of an entity that is connected via a new edge to the graph. Method 1240 may be conducted on a user's local computer system or on a server system for a user. A general order for the operations of the method 1200 is shown in FIG. 12B. Generally, the method 1240 starts with a start operation 1244 and ends with an end operation 1262. The method 1240 can include more or fewer operations or can arrange the order of the operations differently than those shown in FIG. 12C. The method 1240 can be executed as a set of computer-executable instructions executed by a computer system and encoded or stored on a computer readable medium. Further, the method 1240 can be performed by gates or circuits associated with a processor, an application specific integrated circuit (ASIC), a field programmable gate array (FPGA), a system-on-chip (SOC), or other hardware device. Hereinafter, the method 1240 shall be explained with reference to the systems, components, devices, tools, software, data structures, user interfaces, methods, etc. described in conjunction with FIGS. 1-12B and 13A-14B.

At operation 1244, a new entity is received in graph. At operation 1246 the entity's representation is initialized. Said another way, a row for new entity is added to the matrix or representation space. In aspects, all new edges and attributes are ignored at operation 1246.

Next the edge connecting the new entity to the graph is considered. At operation 1248, a determination is made as to what standardized attribute information will flow through the new edge between the new entity and the existing entity to which it is connected. This is the variable v discussed in connection with FIG. 10A.

At operation 1250, a determination is made as to a scaling factor for the entities in the graph, namely how the propagation of the standardized attribute information that flows through the new edge will impact the weights of these attributes on one or more other entities in the graph. This is the variable u discussed in connection with FIG. 10A.

At operation 1252, a determination is made as to what has changed in the graph, this is ΔX as discussed in connection with FIG. 10A and determined based on both what attribute information flows through the new edge (operation 1044) and the scaling factor that determines how this new flow impacts the weights of these attributes on one or more entities in the graph (operation 1046). The representation space (e.g., the matrix) is updated by taking the original representation space and adding to it the change in the representation determined in operations 1248 and 1250.

At operation 1254, it is determined whether the new entity has any new attributes. If it does not (NO at operation 1254), the method 1240 ends. If the new entity does have new attributes (YES at operation 1254), the method 1240 proceeds to operation 1256. At operation 1256, a standardized representation of the new attribute is propagated through the graph as described herein, particularly with regard to FIG. 5. At operation 1258, a determination is made as to the change in the newly propagated attribute's degree of relatedness to one or more of the entities to which the new attribute was propagated. At operation 1260, the representation space (e.g., the matrix) is updated by taking the original representation space and adding to it the change in the representation determined in operation 1146. In effect, a column for the new attribute is added to the relatedness matrix without the need to recalculate all of the weights for all of the other attributes in the matrix. As such, method 1240 is a much more efficient way of accounting for the updated new entity to the graph in the relatedness matrix than calculating the whole matrix again from scratch for a graph with the new entity and new attribute.

FIG. 13 is a block diagram illustrating physical components (e.g., hardware) of a computing device 1300 with which aspects of the disclosure may be practiced. The computing device components described below may be suitable for the computing devices described above. In a basic configuration, the computing device 1300 may include at least one processing unit 1302 and a system memory 1304. Depending on the configuration and type of computing device, the system memory 1304 may comprise, but is not limited to, volatile storage (e.g., random access memory), non-volatile storage (e.g., read-only memory), flash memory, or any combination of such memories. The system memory 1304 may include an operating system 1309 and one or more program tools 1306 suitable for performing the various aspects disclosed herein such. The operating system 1309, for example, may be suitable for controlling the operation of the computing device 1300. Furthermore, aspects of the disclosure may be practiced in conjunction with a graphics library, other operating systems, or any other application program and is not limited to any particular application or system. This basic configuration is illustrated in FIG. 13 by those components within a dashed line 1309. The computing device 1300 may have additional features or functionality. For example, the computing device 1300 may also include additional data storage devices (removable and/or non-removable) such as, for example, magnetic disks, optical disks, or tape. Such additional storage is illustrated in FIG. 13 by a removable storage device 1309 and a non-removable storage device 1310.

As stated above, a number of program tools and data files may be stored in the system memory 1304. While executing on the processing unit 1302, the program tools 1306 (e.g., entity-activity relationship application 1320) may perform processes including, but not limited to, the aspects, as described herein. The entity-activity relationship application 1320 includes a logging tool 1330, a conversion tool 1332, a graphing tool 1334, a propagation tool 1336, and an evaluation tool 1339 as described in more detail with regard to FIG. 1A. Other program tools that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 13 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1300 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 1300 may also have one or more input device(s) 1312, such as a keyboard, a mouse, a pen, a sound or voice input device, a touch or swipe input device, etc. The output device(s) 1314 such as a display, speakers, a printer, etc. may also be included. The aforementioned devices are examples and others may be used. The computing device 1300 may include one or more communication connections 1316 allowing communications with other computing devices 1090. Examples of suitable communication connections 1316 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program tools. The system memory 1304, the removable storage device 1309, and the non-removable storage device 1310 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1300. Any such computer storage media may be part of the computing device 1300. Computer storage media does not include a carrier wave or other propagated or modulated data signal.

Communication media may be embodied by computer readable instructions, data structures, program tools, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 14A and 14B illustrate a computing device or mobile computing device 1400, for example, a mobile telephone, a smart phone, wearable computer (such as a smart watch), a tablet computer, a laptop computer, and the like, with which aspects of the disclosure may be practiced. In some aspects, the client (e.g., computing systems 105 in FIG. 1) may be a mobile computing device. With reference to FIG. 14A, one aspect of a mobile computing device 1400 for implementing the aspects is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. The display 1405 of the mobile computing device 1400 may also function as an input device (e.g., a touch screen display). If included, an optional side input element 1415 allows further user input. The side input element 1415 may be a rotary switch, a button, or any other type of manual input element. In alternative aspects, mobile computing device 1400 may incorporate more or less input elements. For example, the display 1405 may not be a touch screen in some aspects. In yet another alternative aspect, the mobile computing device 1400 is a portable phone system, such as a cellular phone. The mobile computing device 1400 may also include an optional keypad 1435. Optional keypad 1435 may be a physical keypad or a “soft” keypad generated on the touch screen display. In various aspects, the output elements include the display 1405 for showing a graphical user interface (GUI), a visual indicator 1420 (e.g., a light emitting diode), and/or an audio transducer 1425 (e.g., a speaker). In some aspects, the mobile computing device 1400 incorporates a vibration transducer for providing the user with tactile feedback. In yet another aspect, the mobile computing device 1400 incorporates input and/or output ports, such as an audio input (e.g., a microphone jack), an audio output (e.g., a headphone jack), and a video output (e.g., a HDMI port) for sending signals to or receiving signals from an external device.

FIG. 14B is a block diagram illustrating the architecture of one aspect of computing device, a server (e.g., server 109 or server 104), a mobile computing device, etc. That is, the computing device 1400 can incorporate a system (e.g., an architecture) 1402 to implement some aspects. The system 1402 can implemented as a “smart phone” capable of running one or more applications (e.g., browser, e-mail, calendaring, contact managers, messaging clients, games, and media clients/players). In some aspects, the system 1402 is integrated as a computing device, such as an integrated digital assistant (PDA) and wireless phone.

One or more application programs 1466 may be loaded into the memory 1462 and run on or in association with the operating system 1464. Examples of the application programs include phone dialer programs, e-mail programs, information management (PIM) programs, word processing programs, spreadsheet programs, Internet browser programs, messaging programs, and so forth. The system 1402 also includes a non-volatile storage area 1469 within the memory 1462. The non-volatile storage area 1469 may be used to store persistent information that should not be lost if the system 1402 is powered down. The application programs 1466 may use and store information in the non-volatile storage area 1469, such as e-mail or other messages used by an e-mail application, and the like. A synchronization application (not shown) also resides on the system 1402 and is programmed to interact with a corresponding synchronization application resident on a host computer to keep the information stored in the non-volatile storage area 1469 synchronized with corresponding information stored at the host computer. As should be appreciated, other applications may be loaded into the memory 1462 and run on the mobile computing device 1400 described herein.

The system 1402 has a power supply 1470, which may be implemented as one or more batteries. The power supply 1470 might further include an external power source, such as an AC adapter or a powered docking cradle that supplements or recharges the batteries.

The system 1402 may also include a radio interface layer 1472 that performs the function of transmitting and receiving radio frequency communications. The radio interface layer 1472 facilitates wireless connectivity between the system 1402 and the “outside world,” via a communications carrier or service provider. Transmissions to and from the radio interface layer 1472 are conducted under control of the operating system 1464. In other words, communications received by the radio interface layer 1472 may be disseminated to the application programs 1466 via the operating system 1464, and vice versa.

The visual indicator 1420 may be used to provide visual notifications, and/or an audio interface 1474 may be used for producing audible notifications via the audio transducer 1425. In the illustrated configuration, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. In accordance with aspects of the present disclosure, the microphone may also serve as an audio sensor to facilitate control of notifications, as will be described below. The system 1402 may further include a video interface 1476 that enables an operation of an on-board camera 1430 to record still images, video stream, and the like.

A mobile computing device 1400 implementing the system 1402 may have additional features or functionality. For example, the mobile computing device 1400 may also include additional data storage devices (removable and/or non-removable) such as, magnetic disks, optical disks, or tape. Such additional storage is illustrated in FIG. 14B by the non-volatile storage area 1469.

Data/information generated or captured by the mobile computing device 1400 and stored via the system 1402 may be stored locally on the mobile computing device 1400, as described above, or the data may be stored on any number of storage media that may be accessed by the device via the radio interface layer 1472 or via a wired connection between the mobile computing device 1400 and a separate computing device associated with the mobile computing device 1400, for example, a server computer in a distributed computing network, such as the Internet. As should be appreciated such data/information may be accessed via the mobile computing device 1400 via the radio interface layer 1472 or via a distributed computing network. Similarly, such data/information may be readily transferred between computing devices for storage and use according to well-known data/information transfer and storage means, including electronic mail and collaborative data/information sharing systems,

As will be understood from the foregoing disclosure, one aspect of the technology relates to a computer-implemented method of discovering relatedness between entities from a corpora of information. The method comprises automatically extracting attributes from the plurality of heterogeneous entities in a graph; propagating a standardized representation of the extracted attributes from the plurality of heterogeneous entities across the graph; using the propagated attributes to find a degree to which the plurality of heterogeneous entities are associated with the extracted attributes; and using the degree to which the plurality of heterogeneous entities are associated with the extracted attributes to create a representation space illustrating a level of relatedness of an entity to another entity of the plurality of heterogeneous entities. In another example, the representation space is used to determine that two or more of the plurality of heterogeneous entities are related to an activity. In an example, a name of the activity is determined. in an example, the representation space is used to rank search results for a search query that seeks an identity of entities related to an entity of the plurality of heterogeneous entities. In an example, the heterogeneous entities comprise one or more of: an email, a message, a contact, a web search, a web page, a personal information search, a file, and a calendar appointment. In an example, the method is performed entirely on a local computer system. In an example, an update to the graph is added; a delta representation space caused by the update to the graph is determined; and a new representation space is created by adding the delta representation space to the representation space. In an example, an additional edge is added connecting two entities of the plurality of heterogeneous entities in the graph. A change in the representation space is determined by identifying standardized attribute information that will propagate through the new edge and determining an entity scaling factor for the plurality of heterogeneous entities based on the new edge. The representation space is updated based on the change in representation space. In an example, an additional attribute is added to an entity of the plurality of heterogeneous entities in the graph; the additional attribute is propagated across the graph; and the propagated additional attribute is used to update the representation space. In an example, a new entity is added to the graph, wherein the new entity is connected to an existing entity of the plurality of heterogeneous entities by a new edge. A delta representation space is determined by instantiating a new entity representation of the new entity; identifying standardized attribute information that will propagate across the new edge; and determining an entity scaling factor for the plurality of heterogeneous entities based on the new edge. The delta representation space is used to update the representation space. In an example, the representation space is a matrix comprising columns, rows, and entries, wherein each row represents an entity of the plurality of entities, each column represents an attribute of the extracted attributes, and each entry describes a relationship between an entity and an attribute.

In another aspect, the technology relates to a system comprising: at least one processor; and a memory storing instructions that when executed by the at least one processor perform a set of operations. The operations comprise receiving an update to the graph, determining a delta representation space caused by the update to the graph; and creating a new representation space by adding the delta representation space to the representation space. In one example, an additional edge is received connecting two entities of the plurality of heterogeneous entities in the graph. A change in the representation space is determined by identifying standardized attribute information that will diffuse through the new edge and determining an entity scaling factor for the plurality of heterogeneous entities in the graph based on the new edge. The representation space is updated based on the change in representation space. In another example, an additional attribute is added to an entity of the plurality of heterogeneous entities in the graph. The additional attribute is diffused across the graph, and the diffused additional attribute is used to update the representation space. In another example, a new entity is added to the graph, wherein the new entity is connected to an existing entity of the plurality of heterogeneous entities by a new edge. A new entity representation of the new entity is created. A delta representation space is created by determining an identity of standardized attribute information that will diffuse through the new edge; and determining an entity scaling factor for all entities in the graph based on the new edge. The new entity representation and the delta representation space are used to update the representation space. In an example, the heterogeneous entities comprise one or more of: an email, a message, a contact, a web search, a file, and a calendar appointment. In an example, a second update to the graph is received; a delta representation space caused by both of the update and the second update to the graph is determined; and a new representation space is created by adding the delta representation space to the representation space.

In another aspect, the technology relates to a computer-implemented method of discovering relatedness between entities from a user's information. The method comprises constructing a graph from a plurality of heterogeneous entities for the user; automatically extracting attributes from the plurality of heterogeneous entities; propagating the extracted attributes from the plurality of heterogeneous entities across the graph; using the propagated attributes to encode a number describing a degree to which each entity of the plurality of heterogeneous entities is associated with each attribute of the extracted attributes; and using the numbers encoded from the propagated attributes to create a representation space of an entity to another other entity of the plurality of heterogeneous entities. In an example, the representation space is used to determine that two or more of the plurality of heterogeneous entities are related to an activity. In an example, the representation space is used to rank search results for a search query that seeks an identity of entities related to an entity of the plurality of heterogeneous entities.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the operations, functions, and operations discussed herein can be performed continuously and automatically.

The exemplary systems and methods of this disclosure have been described in relation to computing devices. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

A number of variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. in general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various configurations and aspects, includes components, methods, processes, systems and/or apparatus substantially as depicted and described herein, including various combinations, subcombinations, and subsets thereof. Those of skill in the art will understand how to make and use the systems and methods disclosed herein after understanding the present disclosure. The present disclosure, in various configurations and aspects, includes providing devices and processes in the absence of items not depicted and/or described herein or in various configurations or aspects hereof, including in the absence of such items as may have been used in previous devices or processes, e.g., for improving performance, achieving ease, and/or reducing cost of implementation.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use of the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an configuration with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method of discovering relatedness between entities from a corpora of information, the method comprising:
automatically extracting attributes from the plurality of heterogeneous entities in a graph;
propagating a standardized representation of the extracted attributes from the plurality of heterogeneous entities across the graph;
using the propagated attributes to find a degree to which the plurality of heterogeneous entities are associated with the extracted attributes; and
using the degree to which the plurality of heterogeneous entities are associated with the extracted attributes to create a representation space illustrating a level of relatedness of an entity to another entity of the plurality of heterogeneous entities.

2. The computer-implemented method of claim 1 further comprising:
using the representation space to determine that two or more of the plurality of heterogeneous entities are related to an activity.

3. The computer-implemented method of claim 2 further comprising:
determining a name of the activity.

4. The computer-implemented method of claim 1 further comprising:
using the representation space to rank search results for a search query that seeks an identity of entities related to an entity of the plurality of heterogeneous entities.

5. The computer-implemented method of claim 1 wherein the heterogeneous entities comprise one or more of: an email, a message, a contact, a web search, a web page, a personal information search, a file, and a calendar appointment.

6. The computer-implemented method of claim 1 wherein the method is performed entirely on a local computer system.

7. The computer-implemented method of claim 1 further comprising:
adding an update to the graph;
determining a delta representation space caused by the update to the graph; and
creating a new representation space by adding the delta representation space to the representation space.

8. The computer-implemented method of claim 1 further comprising
adding an additional edge connecting two entities of the plurality of heterogeneous entities in the graph;
determining a change in the representation space by:
determining an identity of standardized attribute information that will propagate through the new edge;
determining an entity scaling factor for the plurality of heterogeneous entities based on the new edge; and
updating the representation space based on the change in representation space.

9. The computer-implemented method of claim 1 further comprising:
adding an additional attribute to an entity of the plurality of heterogeneous entities in the graph;
propagating the additional attribute across the graph; and
using the propagated additional attribute to update the representation space.

10. The computer-implemented method of claim 1 further comprising:
adding a new entity to the graph, wherein the new entity is connected to an existing entity^{,} of the plurality of heterogeneous entities by a new edge;
determining a delta representation space by:
instantiating a new entity representation of the new entity;
identifying standardized attribute information that will propagate across the new edge; and
determining an entity scaling factor for the plurality of heterogeneous entities based on the new edge; and
using the delta representation space to update the representation space.

11. The computer-implemented method of claim 1 wherein the representation space is a matrix comprising columns, rows, and entries, wherein each row represents an entity of the plurality of entities, each column represents an attribute of the extracted attributes, and each entry describes a relationship between an entity and an attribute.

12. A computer system for updating a representation space illustrating a level of relatedness between a plurality of heterogeneous entities, wherein one or more of the heterogeneous entities have an attribute and the heterogeneous entities are connected by edges in a graph, the system comprising:
a processor;
a memory operably coupled to the processor, wherein the memory stores computer executable instructions that, when executed, cause the processor to:
receive an update to the graph;
determine a delta representation space caused by the update to the graph; and
create a new representation space by adding the delta representation space to the representation space.

13. The computer system of claim 12, further comprising computer executable instructions that, when executed, cause the processor to:
receive an additional edge connecting two entities of the plurality of heterogeneous entities in the graph;
determine a change in the representation space by:
identifying standardized attribute information that will diffuse through the new edge; and
determining an entity scaling factor for the plurality of heterogeneous entities in the graph based on the new edge; and
update the representation space based on the change in representation space.

14. The computer system of claim 12, further comprising computer executable instructions that when executed cause the processor to:
add an additional attribute to an entity of the plurality of heterogeneous entities in the graph;
diffuse the additional attribute across the graph; and
use the diffused additional attribute to update the representation space.

15. The computer system of claim 12, further comprising computer executable instructions that when executed cause the processor to:
add a new entity to the graph, wherein the new entity is connected to an existing entity of the plurality of heterogeneous entities by a new edge;
create a new entity representation of the new entity;
determine a delta representation space by:
identifying standardized attribute information that will diffuse through the new edge; and
determining an entity scaling factor for all entities in the graph based on the new edge; and
use the new entity representation and the delta representation space to update the representation space.

16. The computerized system of claim 12 wherein the heterogeneous entities comprise one or more of: an email, a message, a contact, a web search, a file, and a calendar appointment.

17. The computer system of claim 12, further comprising computer executable instructions that when executed cause the processor to:
receive a second update to the graph;
determine a delta representation space caused by both of the update and the second update to the graph; and
create a new representation space by adding the delta representation space to the representation space.

18. A computer-implemented method of discovering relatedness between entities from a user's information, the method comprising:
constructing a graph from a plurality of heterogeneous entities for the user;
automatically extracting attributes from the plurality of heterogeneous entities;
propagating the extracted attributes from the plurality of heterogeneous entities across the graph;
using the propagated attributes to encode a number describing a degree to which each entity of the plurality of heterogeneous entities is associated with each attribute of the extracted attributes; and
using the numbers encoded from the propagated attributes to create a representation space of an entity to another other entity of the plurality of heterogeneous entities.

19. The computer-implemented method of claim 18 further comprising:
using the representation space to determine that two or more of the plurality of heterogeneous entities are related to an activity.

20. The computer-implemented method of claim 18 further comprising:
using the representation space to rank search results for a search query that seeks an identity of entities related to an entity of the plurality of heterogeneous entities.
